(19) United States
(12) Patent Application Publication
(10) Pub. No.: US 2010/0268748 A1
(43) Pub. Date: Oct. 21, 2010

(54) SYSTEM AND METHOD OF UPDATING SUPPLIER INFORMATION

(75) Inventor: FEI-RONG WANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY(ShenZhen) CO., LTD., Shenzhen City (CN); HON HAI PRECISION INDUSTRY CO.,LTD., Tu-Cheng (TW)

(21) Appl. No.: 12/497,639

(22) Filed: Jul. 3, 2009

(30) Foreign Application Priority Data
Apr. 20, 2009 (CN) 200910301683.3

(51) Int. Cl. G06F 17/00

(52) U.S. Cl. 707/803; 707/E17.045

(57) ABSTRACT

A supplier information updating system in communication with an order system and a stock system of a manufacturer includes a supplier database operable to store information regarding suppliers of the manufacturer and a part database operable to store information regarding various parts provided by the suppliers. The system obtains inquiry results regarding the parts and corresponding suppliers, and updates the information regarding the parts and corresponding suppliers according to the inquiry results. The system further generates an unqualified part list including the unqualified parts and corresponding suppliers according to the updated information regarding the parts and corresponding suppliers, marks one or more part orders including the newly added unqualified parts and corresponding suppliers, and provides the marked part orders to the order system of the manufacturer.

### BACKGROUND

1. Technical Field

Embodiments of the present disclosure relate to data processing, and more particularly to a system and a method of updating supplier information.

2. Description of Related Art

With the development of integrated manufacturing, more and more manufacturers operate at a large scale, with product varieties produced thereby following on an equally large scale with frequent changes. The manufacturer must access a large number of suppliers/vendors to provide parts. Customers are the primary determiner of quality and environmental standard of the manufactured products, including parts from the suppliers. Such information is fed back to the manufacturer, as often as on a daily or weekly basis. Accordingly, supplier information at the manufacturer side must be frequently updated.

Often, customers send the results to the manufacturer by email, with updates processed manually utilizing a spreadsheet utility. Usually, inquiry results received daily can number in the millions for large scale manufacturer, rendering updates to supplier information susceptible to inefficiency and error. There is, as a result, a need to overcome the limitations described.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of an application environment and functional modules of one embodiment of a supplier information updating system of the present disclosure; and

FIG. 2 is a flowchart of one embodiment of a method of updating supplier information in accordance with the present disclosure.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

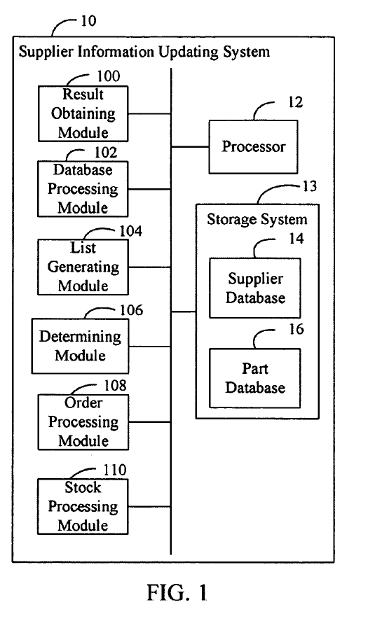

FIG. 1 is a schematic diagram of an application environment and functional modules of a supplier information updating system 10 of the present disclosure. In one embodiment, the supplier information updating system 10 may run on a data processing device, such as a server, a personal computer, or a notebook. The supplier information updating system 10 communicates with an order system and a stock system and is operable to update information regarding parts and corresponding suppliers of a manufacturer, such as part qualification.

The supplier information updating system 10 includes a processor 12, a storage system 13, a supplier database 14, a part database 16, a result obtaining module 100, a database processing module 102, a list generating module 104, a determining module 106, an order processing module 108, and a stock processing module 110. The processor 12 executes the modules, and may be a central processing unit (CPU) of the data processing device. The supplier database 14 and the part database 16 may be both stored in the storage system 13.

The supplier database 14 is operable to store information regarding suppliers for the manufacturer. In one embodiment, the information regarding the suppliers can include supplier indices, names, environment standard rating, and other information. Each supplier index corresponds to one supplier.

The part database 16 is operable to store information regarding various parts provided by the suppliers of the manufacturer. In one embodiment, the information regarding the parts includes part indices, part names, specifications, part prices, and the supplier indices related to the parts, for example. A part index of the supplier uniquely corresponds to one part.

The result obtaining module 100 is operable to obtain inquiry results for parts and corresponding suppliers. Each of the inquiry results contains qualification of one or more parts and corresponding supplier. In one embodiment, customers can continuously check part quality and return the results to the supplier information updating system 10 daily or weekly. Each of the inquiry results includes a part index, a supplier index, environment standard rating, for example.

The database processing module 102 is operable to update the information regarding unqualified and qualified parts and corresponding suppliers in the supplier database 14 and the part database 16 according to the inquiry results. In one embodiment, the database processing module 102 can match each part index of the inquiry result with the part database 16 and update the information regarding the environment standard rating corresponding to the matched part indices. The database processing module 102 updates the information regarding the related suppliers according to the supplier indices related to the matched part indices. Accordingly, the supplier information updating system 10 automatically updates supplier information, which greatly improves efficiency.

The list generating module 104 is operable to generate an unqualified part list and a qualified part list according to the updated information regarding the parts and corresponding suppliers. The unqualified part list includes at least one unqualified part and a corresponding supplier in the updated part database 16 and the updated supplier database 14. The qualified part list includes all qualified parts and corresponding suppliers in the updated part database 16 and the updated supplier database 14. The list generating module 104 is further operable to provide the qualified part list to the order system of the manufacturer via a communication network, such as Internet or an intranet, for example.

The determining module 106 is operable to determine if there is at least one newly added unqualified part and a corresponding supplier in the unqualified part list.

The order processing module 108 is operable to mark one or more part orders including the newly added unqualified parts and corresponding suppliers, and provide the marked part orders to the order system of the manufacturer upon the condition that there is at least one newly added unqualified part and corresponding supplier. In one embodiment, the order processing module 108 can match each part of the part orders with the newly added unqualified parts and corresponding suppliers in the unqualified part list. If the part has no match on the unqualified part list, the part is qualified and the corresponding part order need not be processed. If the part can be matched with the unqualified part list, the part is unqualified. The order processing module 108 marks the related part order of the unqualified part with an identifying color, such as red. In one embodiment, the list generating module 104 further provides the qualified part list to the order system of the manufacturer. The order system of the manufacturer can choose parts and suppliers from only the qualified part list.

The stock processing module 110 is operable to generate an unqualified stock list according to the newly added unqualified parts and corresponding suppliers and provide the unqualified stock list to the stock system of the manufacturer upon the condition that there is at least one newly added unqualified part and corresponding supplier. The unqualified stock list includes newly added unqualified parts in the stock system at the manufacturer. In one embodiment, the manufacturer may have a stock database operable to store stock information regarding the parts in the stock system. The stock information includes part information such as part indices, related supplier indices, specification, prices, and others. The stock processing module 110 matches each part index in the stock database with the newly added unqualified parts and corresponding suppliers in the unqualified part list. If no match can be made with the unqualified part list, the part is qualified and the corresponding stock information does not need to be processed. If the part can be matched with the unqualified part list, the part is unqualified. The stock processing module 110 updates the corresponding stock information in the stock database and then generates the unqualified stock list.

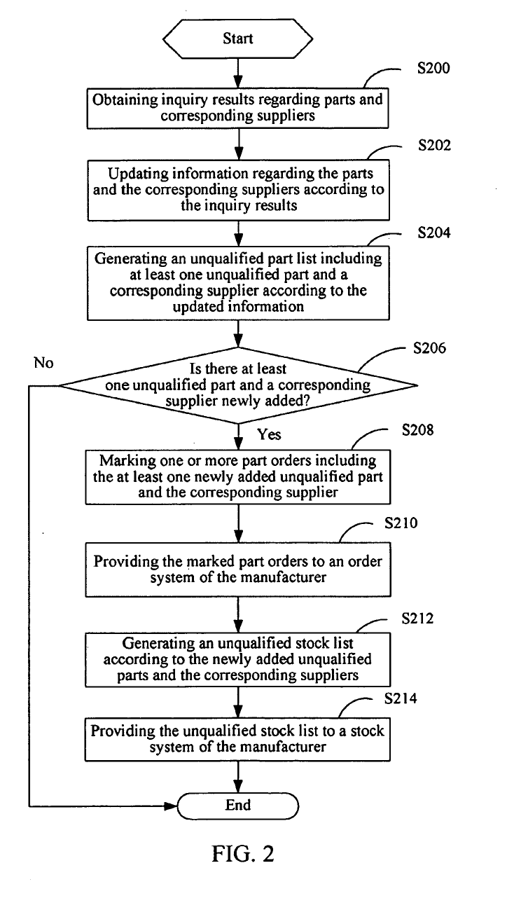

FIG. 2 is a flowchart of one embodiment of a method of updating supplier information in accordance with the present disclosure. The method may be embodied in the supplier information updating system 10, and is executed by the functional modules such as those of FIG. 1. Depending on the embodiment, additional blocks may be added, others deleted, and the ordering of the blocks may be changed while remaining well within the scope of the disclosure.

In block S200, the result obtaining module 100 obtains inquiry results regarding the parts and corresponding suppliers. As mentioned above, each of the inquiry results indicates qualification of one or more parts and corresponding suppliers and includes a part index, a supplier index, environment standard rating, and others.

In block S202, the database processing module 102 updates the information regarding the unqualified and qualified parts and corresponding suppliers according to the inquiry results. For example, if inquiry results show one part has no environment standard rating, the database processing module 102 matches the part index of the part with the part database 16, updates the information regarding the part, and updates the information regarding the related suppliers in the supplier database 14.

In block S204, the list generating module 104 generates an unqualified part list according to the updated information regarding the parts and corresponding suppliers. As mentioned above, the unqualified part list includes at least one unqualified part and a corresponding supplier in the updated information regarding the qualified or unqualified parts and corresponding suppliers.

In block S206, the determining module 106 determines if there is at least one newly added unqualified part and corresponding supplier.

If there is at least one newly added unqualified part and corresponding supplier, then in block S208, the order processing module 108 marks one or more part orders including the at least one newly added unqualified part and corresponding supplier. For example, if there is a plurality of newly added unqualified parts, the order processing module 108 matches each part of the part orders with the newly added unqualified parts and corresponding suppliers. The order processing module 108 marks the matched part order.

In block S210, the order processing module 108 provides the marked part orders to the order system of the manufacturer. For example, the order system of the manufacturer can be used by all staff related to the part order, such as those using, ordering, and purchasing the part, and others. After receiving the marked part orders, the order system of the manufacturer processes the part order.

In block S212, the stock processing module 110 generates an unqualified stock list according to the at least one newly added unqualified part and corresponding supplier. As mentioned above, the unqualified stock list includes the newly added unqualified parts which are in the stock system of the manufacturer. For example, if there is a plurality of part information in the stock database, the stock processing module 110 matches part information with the newly added unqualified parts and corresponding suppliers to determine if the stock corresponding to the part information is unqualified. If the stock is unqualified, the stock processing module 110 updates the stock information in the stock database and adds the stock to the unqualified stock list.

In block S214, the stock processing module 110 provides the unqualified stock list to the stock system of the manufacturer. For example, the stock system of the manufacturer can be used by all staff related to the stock, such as those using, ordering, purchasing, and managing warehousing of, the part, and others. After receiving the unqualified stock list, the stock system of the manufacturer processes the stock, such as using another qualified part, untreading the part, and others.

The supplier information updating system 10 of the present disclosure automatically updates supplier information of a large-scale manufacturer, greatly increasing efficiency of the manufacturer. The supplier information updating system 10 can further remind the order system of the manufacturer and the stock system of the manufacturer to promptly process the related parts by way of the order processing module and the stock processing module, which greatly reduces cost regarding the parts and improves part quality.

While various embodiments and methods of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A supplier information updating system in communication with an order system and a stock system of a manufacturer, the supplier information updating system comprising a processor, a storage system, and one or more programs, wherein the one or more programs are stored in the storage system and operable to be executed by the processor, the programs comprising:
a supplier database operable to store information regarding suppliers of the manufacturer in the storage system;
a part database operable to store information regarding various parts provided by the suppliers of the manufacturer in the storage system;
a result obtaining module operable to obtain inquiry results regarding the parts and corresponding suppliers, wherein each of the inquiry results indicates qualification of one or more parts and a corresponding supplier;
a database processing module operable to update the information regarding the parts and corresponding suppliers in the supplier database and the part database according to the inquiry results;
a list generating module operable to generate an unqualified part list comprising at least one unqualified part and a corresponding supplier according to the updated information regarding the parts and the corresponding suppliers;
a determining module operable to determine if there is at least one newly added unqualified part and a corresponding supplier in the unqualified part list; and
an order processing module operable to mark one or more part orders comprising the at least one newly added unqualified part and the corresponding suppliers and provide the marked part orders to the order system of the manufacturer upon the condition that there is the at least one newly added unqualified part and the corresponding supplier.

2. The system as claimed in claim 1, wherein the list generating module is further operable to generate a qualified part list comprising the qualified parts and the qualified suppliers according to the updated part database and the updated supplier database.

3. The system as claimed in claim 2, wherein the list generating module is further operable to provide the qualified part list to the order system of the manufacturer via a communication network.

4. The system as claimed in claim 1, further comprising a stock processing module operable to generate an unqualified stock list comprising parts in the stock system which match the newly added unqualified parts and corresponding suppliers upon the condition that there is the at least one newly added unqualified part and the corresponding supplier.

5. The system as claimed in claim 4, wherein the stock processing module is further operable to provide the unqualified stock list to the stock system of the manufacturer.

6. A method of updating supplier information used by a manufacturer, comprising:
storing information regarding suppliers of the manufacturer in a supplier database in a storage system;
storing information regarding various parts provided by the suppliers of the manufacturer in a part database in the storage system;
obtaining inquiry results regarding the parts and corresponding suppliers, wherein each of the inquiry results indicates qualification of one or more parts and corresponding suppliers;
updating the information regarding the parts and corresponding suppliers in the supplier database and the part database according to the inquiry results;
generating an unqualified part list comprising at least one unqualified part and a corresponding supplier according to the updated information regarding the parts and corresponding suppliers in the supplier database and the part database;
determining if there is at least one unqualified part and a corresponding supplier newly added to the unqualified part list;
marking one or more part orders comprising the at least one newly added unqualified part and the corresponding supplier if there is the at least one newly added unqualified part and the corresponding supplier;
providing the marked part orders to the order system of the manufacturer; and
processing the above blocks with at least one processor.

7. The method as claimed in claim 6, further comprising:
generating a qualified part list comprising the qualified parts and the qualified suppliers according to the updated part database and the updated supplier database; and
providing the qualified part list to the order system of the manufacturer via a communication network.

8. The method as claimed in claim 6, further comprising:
generating an unqualified stock list according to the newly added unqualified parts and the corresponding suppliers if there is the at least one newly added unqualified part and the corresponding supplier, wherein the unqualified stock list comprises parts in the stock system which match the newly added unqualified parts; and
providing the unqualified stock list to the stock system of the manufacturer.
